(19) United States
(12) Patent Application Publication
(10) Pub. No.: US 2008/0183605 A1
(43) Pub. Date: Jul. 31, 2008

(54) System and Method for Equity-Based Compensation Accounting

(76) Inventor: Ramy R. Taraboulsi, Toronto (CA)

Correspondence Address: GOWLING LAFLEUR HENDERSON, LLP;Suite 2600, 160 Elgin Street, Ottawa, ON, K1P 1C3, omitted

(21) Appl. No.: 11/871,303

(22) Filed: Oct. 12, 2007

Related U.S. Application Data
(60) Provisional application No. 60/829,150, filed on Oct. 12, 2006.

(51) Int. Cl. G06Q 10/00

(52) U.S. Cl. 705/30

(57) ABSTRACT

A system for employee equity based compensation accounting, comprising a database for storing granting information derived from one or more equity based compensation grants to an employee, said database being configured to have a normalized data structure for storing said granting information; and a reporting module for generating from said stored granting information accounting entries corresponding to plurality of sub ledger accounts, the accounts representing accounting debits and credits in said sub ledger for at least one of issuing, expensing, exercising and expiring one or more of said equity based compensation grants.

### CROSS REFERENCE TO RELATED APPLICATIONS

This application claims the benefit of US Provisional application No. 60/829,150 filed, Oct. 12, 2006.

### FIELD OF THE INVENTION

The present invention relates generally to information processing environments, and more particularly to a system and method for improving performance of computer implemented systems for accounting for employee equity based compensation, such as employee stock option compensation plans.

### BACKGROUND OF THE INVENTION

Computer based accounting systems utilize a relational database and typically use a double entry accounting scheme to record transaction information where each value is stored twice, once as a credit (a positive value) against one account, once as a debit (a negative value) against another account. There are a number of rules that control these values. The main rules are i) every entry into the system must balance—i.e. the sum of any transaction must be zero; ii) the sum of all the values in the system at any one time must be zero (the ‘trial balance’); iii) no values can ever be amended or deleted. They must be negated with an opposing entry (a ‘contra’) and re-entered (‘re-booked’). This provides a completely secure audit trail.

By way of background, the accounting process maybe defined by a series of activities that begins with a transaction and ends with the closing of the books. Because this process is repeated each reporting period, it is referred to as the accounting cycle and includes major steps of i) Identify the transaction or other recognizable event; ii) Analyze and classify the transaction—this step involves quantifying the transaction in monetary terms (e.g. dollars and cents), identifying the accounts that are affected and whether those accounts are to be debited or credited; iii) record the transaction by making entries in the appropriate journal—the journal is the point of entry of business transactions into the accounting system. It is a chronological record of the transactions, showing an explanation of each transaction, the accounts affected, whether those accounts are increased or decreased, and by what amount; iv) post general journal entries to the ledger accounts—the ledger is a collection of the companies accounts. While the journal is organized as a chronological record of transactions, the ledger is organized by account and in the double entry system transactions are recorded in at least two accounts, a typical general journal entry takes the following form:

| | | | |
|---|---|---|---|
| Date | Name of account being debited | Amount | |
| | Name of account being credited | | Amount |
| | Optional: short description of transaction | | |

As mentioned above the end of the accounting period involves the preparation of the financial statements for the company. Once adjusting entries have been made or entered into a worksheet, the financial statements can be prepared using information from the ledger accounts. Because some of the financial statements use data from the other statements, the following is a logical order for their preparation: i) Income statement: prepared from the revenue, expenses, gains, and losses ii) Balance sheet: prepared from the assets, liabilities, and equity accounts and iii) Statement of retained earnings: prepared from net income and dividend information.

With new reporting regulations such as CICA-3870 and FAS 123 increased burdens have been placed on accounting systems for transactions involving equity based compensation. For example, these new reporting regulations have placed a burden on public and private companies to report the impact of their employee stock based compensation on their financial statements. Typically, employee stock based compensation was reported just as a note on the financial statements, that is, employee stock plans had no impact on the financial statements. Historically, employers have been required to recognize the value of stock options as a compensation expense for financial accounting purposes only when exercised rather than when granted. In December 2004, the Financial Accounting Standards Board (the “FASB”) issued its Statement of Financial Accounting Standard #123 (revised) relating to “share based payments”. This Statement requires a public entity to measure the cost of employee services received in exchange for an award of equity instruments, which includes stock options, based on the grant-date fair value of the award, and to recognize such cost over the period during which an employee is required to provide service in exchange for the award.

It is now required that companies should recognize the compensation their employees receive in the form of stock based compensation, such as stock options, as an expense on the company's income statement. To properly report its earnings, an employer will now be required to determine its actual expense arising from the grant of each employee stock option. The most accurate indication of such expense will be the option's fair market valve on the grant date. While there are standard methods for valuing options that trade on an exchange, there are a number of features of employee stock options that make it difficult to apply these standard methods. For instance, there is usually a vesting period during which options cannot be exercised. When employees leave their jobs they typically lose unvested options and abandon any vested options that are out of the money. Generally, employees are not permitted to sell their options. They must exercise the options and sell the underlying shares in order to realize a cash benefit. As a result employee stock options tend to be exercised earlier than similar regular options. There is also some dilution when employee stock options are exercised. Also vesting of the stock options is done on the basis of a vesting schedule. For accounting purposes stock based compensation is recognized over the vesting period to which the grant relates. An amortization schedule is used to recognize the accounting costs and depends on the vesting schedule and whether the award is fixed or variable. For example cliff vesting schedule allows for 100% vesting on a specified future date such as the fourth anniversary of the grant date. The cost of such an award would be recognized in equal installments over the four years of the vesting period can take many forms, for example cliff vesting.

It may be appreciated that in order to capture all accounting entries for a particular options transactions requires a significant number of entries to be made in a double entry system. Furthermore, because of the unique features of employee stock based compensation as mentioned above, a number of adjusting entries may have to be made before the financial statements can be prepared.

Typically, most CFOs build their own spreadsheets to perform the calculations, or manage their options inaccurately and just provide an estimate of the impact on the financial statements. The first alternative is very time consuming; the second is incorrect. Since financial statements for tax purposes must be based on actual data. In both cases, financial auditors spend a considerable amount of time verifying the numbers produced, resulting in very high costs to the company and in many cases requiring a restatement of their financial results and a redoing of their financial statements. Finance departments in a company may spend up to a week every quarter to keep track of the activities, and correctly calculate the value of each employee's options.

Solutions have been proposed, for example US Patent Publication No. 2006/0212377, which discloses a computer system and method for reporting, and analyzing grants for equity based compensation, wherein the system stores information regarding grants down to each individual grant level and then uses this information to produce reports such as required by accounting regulations like FASB. However this system is not capable of, in a reasonable amount of time, showing or reporting vesting amortization transactions that have an impact on the financial statements of the company nor is it capable of showing both a summary and underlying detail of vesting amortization financial transactions that are generated as a result of issuing, exercising and expiring stock-backed compensation.

One reason for this limitation is that the double-entry accounting journal entries stored in a non-normalized database results in a large amount of data which must be saved and retrieved from hard disk storage. This creates a data bottleneck due to the limited performance of hard disks and thus taking an impractical amount of time to produce appropriate reports. The performance problems associated with the disk bottleneck results from the fact that the CPU performance over the last few years has improved dramatically to the extent that adding CPU power to most applications does not result in an improvement in the performance, and the only way to improve the performance is via minimizing data that is being stored and retrieved from the database.

Accordingly there is a need for a system and method that mitigates at least some of the above disadvantages.

### SUMMARY OF THE INVENTION

There is a need for a system and method for tracking all activities related to employee stock based compensation in real time for public and private companies.

In accordance with a further embodiment of the invention there is provided a graphical user interface and reporting features that allow a user to easily view an employee's options and warrants are, calculate the price of options at any time, or whenever an employee exercises his/her options, and calculate the value over any period of time.

The system generates sub-ledger entries for stock based compensation transactions, the sub-ledger provides a mechanism for differentiation and segregation of vesting and expensing of derivative products as separate transactions. In accordance with this invention there is provided a system for employee equity based compensation accounting, comprising:
a database for storing granting information derived from one or more equity based compensation grants to an employee, said database being configured to have a normalized data structure for storing said granting information; and
a reporting module for generating from said stored granting information accounting entries corresponding to plurality of sub ledger accounts, the accounts representing accounting debits and credits in said sub ledger for at least one of issuing, expensing, exercising and expiring one or more of said equity based compensation grants.

In accordance with a further aspect of the invention there is provided a method for employee equity based compensation accounting, comprising the steps of:
Storing in a database granting information derived from one or more equity based compensation grants to an employee, said database being configured to have a normalized data structure for storing said granting information; and
generating from a reporting module for generating from said stored granting information accounting entries corresponding to plurality of sub ledger accounts, the accounts representing accounting debits and credits in said sub ledger for at least one of issuing, expensing, exercising and expiring one or more of said equity based compensation grants.

### BRIEF DESCRIPTION OF THE DRAWINGS

The present invention will be further understood from the following detailed description with reference to the drawings in which:

FIGS. 1a and 1b are schematic diagrams of a timeline for employee stock option;

FIG. 2 is a block diagram of the system components according to an embodiment of the present invention;

FIG. 3 is an entity relationship diagram for a normalized database according to an embodiment of the present invention;

FIG. 4 is a flow chart showing the generation of a sub ledger report;

FIG. 5 is a graphical user interface screen for inputting employee stock based compensation transaction information according embodiment of the present invention;

FIG. 6 is a display screen showing vesting and accounting vesting transactions generated according to an embodiment of the present invention;

FIG. 7 is a display screen for adding an options contract transaction type to an existing options contract;

FIG. 8 is a use case diagram; and

FIG. 9 is a flow chart showing a use of the system.

### DETAILED DESCRIPTION OF PREFERRED EMBODIMENTS

In the following description like references refer to like structures in the drawings.

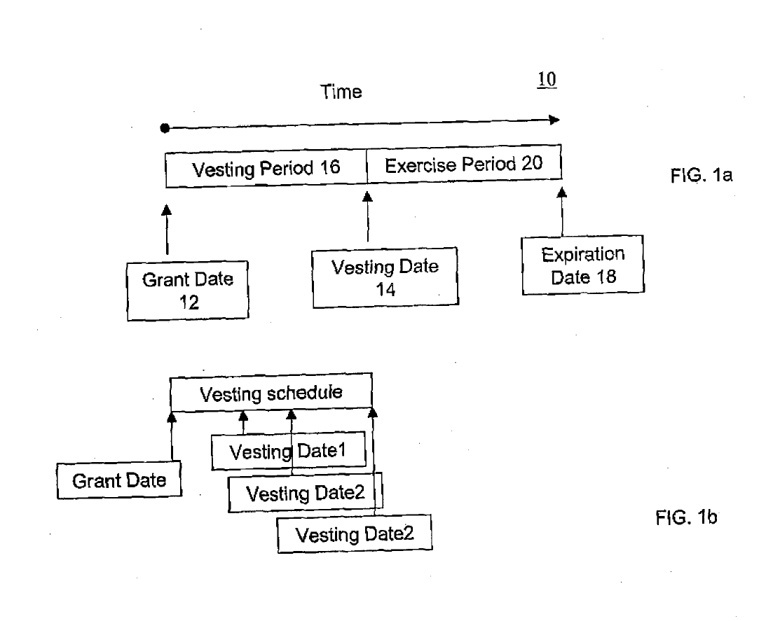

Referring to FIG. 1a there is shown a time line 10 which provides a representation of the parameters that define a typical employee stock option (ESO).

The ESO exists with fixed terms as an enforceable contract as of the Grant Date 12. The contract vests on the Vesting Date 14. The period of time from the Grant Date 12 to the Vesting Date 14 is called the Vesting Period 16. The contract matures, or ceases to exist, on its Expiration Date 18. The Expiration date 18 is also the Maturity Date of the option. The period from the Vesting Date to the Maturity Date is the Exercise Period 20. The Vesting Date 14 is taken as the first date when the ESO may be exercised. The ESO may be exercised on any date during the Exercise Period 20. If it is exercised prior to the maturity of the ESO, the contract ceases to exist; as a result of this exercise feature the expected maturity of the contract may be a period of time equal to the period described as “between a date that is the same or earlier than the Maturity Date and the same or longer than the Vesting Date”. The Strike Price, also known as the Exercise Price and a Black-Scholes variable, is the price that the option holder must pay to purchase a share of stock through the option contract instead of through an open market purchase.

Not all ESO's are alike. Many compensation plans feature options that are exercisable by an employee in accordance with a vesting schedule, that may be all-at-once(“cliff vesting”) or graded (vested proportionally over time) as for example illustrated in FIG. 1b.

While the contract may be exercised at any time during the Exercise Period, it is commonly accepted that exercise will only occur if the Market Price of the stock that is the “underlying item” in the option is more than the Strike Price in the option (that is, the option is “in the money”); “at the money” and “out of the money” options will almost surely mature and expire unexercised.

The following accounting issues arise in the course of the accounting for ESOs: the date at which the ESO should be recognized in the financial statements: use of the Grant Date as the date the option contracts must first be recognized in the balance sheet, and the use of the Strike Price as the balance sheet carrying value of the share that is transferred to the option holder upon exercise.

The present invention seeks to provide a system that is capable of optimizing access time in data intensive financial transactions such as vesting and expensing of employee stock based compensation plans and which provides a detailed record of all transactions for auditors.

The system generates a sub-ledger entries for all the options and derivative transactions that have an impact on the financial statements of the company. This sub-ledger is generated dynamically by issuing an SQL query statement to a normalized database, and shows both the summary and detail of all the financial transactions that are generated as a result of issuing, exercising and expiring stock-backed compensation derivatives.

In addition, the system allows the users to apply various filters to this sub-ledger such as for example by department (employee group or cost centre), option plan, date range and even specific employee.

A benefit of this dynamic sub-ledger is providing exact details of how the accounting of options is done on the financial statements, thereby reducing the auditing costs. Unlike other financial systems, the present system does not store option information on the basis of an accounting double entry. Instead, the present system maintains the records for the award or grant in a “fully normalized” fashion on a database. When required, the double entries (for the sub-ledger) are generated dynamically via a reporting query. The benefits of this are that of:
a. maintaining the integrity of the database, and eliminating the possibility of data integrity problems;
b. additional flexibility in the generation of the sub ledger in case new accounting rules are introduced, or existing account rules are changed;
c. a capability of automatically generating the comments that are associated with the sub ledger;
d. performance gains.

In the present context, a non-normalized database structure can suffer from data anomalies. A non-normalized database structure may store data representing a particular referent in multiple locations. An update to such data in some but not all of those locations results in an update anomaly, yielding inconsistent data. A normalized database structure prevents such an anomaly by storing such data (i.e. data other than primary keys) in only one location.

A non-normalized database may have inappropriate dependencies, i.e. relationships between data with no functional dependencies. Adding data to such a database may require first adding the unrelated dependency. A normalized database prevents such insertion anomalies by ensuring that database relations mirror functional dependencies.

Similarly, such dependencies in non-normalized databases can hinder deletion. That is, deleting data from such databases may require deleting data from the inappropriate dependency. A normalized database prevents such deletion anomalies by ensuring that all records are uniquely identifiable and contain no extraneous information.

Normalized databases have a design that reflects the true dependencies between tracked quantities, allowing quick updates to data with little risk of introducing inconsistencies. Instead of attempting to lump all information into one table, data is spread out logically into many tables. Normalizing the data is decomposing a single relation into a set of smaller relations, which satisfy the constraints of the original relation. Decomposing the tables can solve redundancy. However certain new problems are caused by decomposition.

The present invention provides for the differentiation between and independent storage of the vesting information from the expensing transaction information i.e. decoupling of the vesting and expensing transactions while maintaining loose relationship between them.

The present system allows users to define different transactions as either vesting or accounting vesting. The system makes this decision based on the contract parameters that the user has previously entered into the system at the time of recording the grant of the stock options. The vesting transaction arises when the employee (option holder) can exercise the option or derivative, while the accounting vesting transactions arise when the option or derivative is expensed.

The present system automatically creates the accounting vesting (amortization) transactions from a vesting schedule based on various accounting rules as defined by GAAP (generally accepted accounting principles). A benefit of this feature is that it provides the capability to generate various kinds of reports and at the same time provide the facility to accommodate any accounting rules for expensing the options across different companies and countries in an optimal amount of time.

The system stores all the transactions (vesting, expensing, exercising and expiry—rules are based on FAS-123R and CICA-3870) in a single data structure transaction table identified below, and also stores the business rules associated with each of these types of transactions at the database level in a transaction table (transactions may include for example credit an expense account and debit an equity or liability account). The reference table (identified as trx_type_r below) holds the different types of option transactions, for example issuing, expiring assigning exercising etc. Maintaining this distinction between the different transaction types, while keeping them in the same table, although inconsistent with common logic, maintains a loose coupling between exercising and expensing options, while still maintaining a tight integrated relationship between them.

The benefit of the present system could be summarized as follows:

The storage of the business rules associated with the different transactions on the database enables us to make changes to these rules in a transaction reference table named trx_type_r in an easy and straightforward manner if the accounting rules associated with them are changed, or if new rules are introduced new types of transactions an be added by just modifying reference tables on the database level. For example depending on the type of option plan, the credited account would be the equity account or the liability account. This is driven by the category of the plan as identified in an option plan type table named option_plan_type_r.

Storing these transactions in the same database simplifies the reporting while allowing for more sophisticated reports.

The present invention thus significantly improves the performance of the system reporting.

In one aspect of the invention, the employer establishes an employee stock option plan. The employer will then establish a grant or issue date upon which it expects to distribute or issue a number of stock options to its employees. The employer will establish the characteristics, terms, conditions and restrictions of the proposed grant. The employee stock option restrictions may be selected from the group consisting of: a vesting period, an exercise period, a forfeiture upon termination condition, a non-transferable condition, a strike price, a number of shares allocated to the employee stock option, a vesting date, and an expiration date.

Accordingly there is provided A system for processing data on a general purpose computer for a plurality of equity based compensation plans and a plurality of participants, each of the compensation plans having a time-variant unit value, the system comprising: (a) transaction storage for storing transaction records containing externally-supplied grant transaction information, said grant transaction information identifying one of the participants, at least one equity type, an equity type unit value, a transaction effective date, a transaction type, an amount of equity unit granted to the identified participant and a schedule for vesting of said equity type with said participant; (b) amortization storage for storing an amortization schedule generated from said schedule for vesting; and (c) a report generation module coupled to said transaction storage and to said amortization storage for extracting data from the transaction records and generating debits and credits using the equity type, transaction effective date and amortization schedule to determine the equity based compensation plan value as of the transaction effective date.

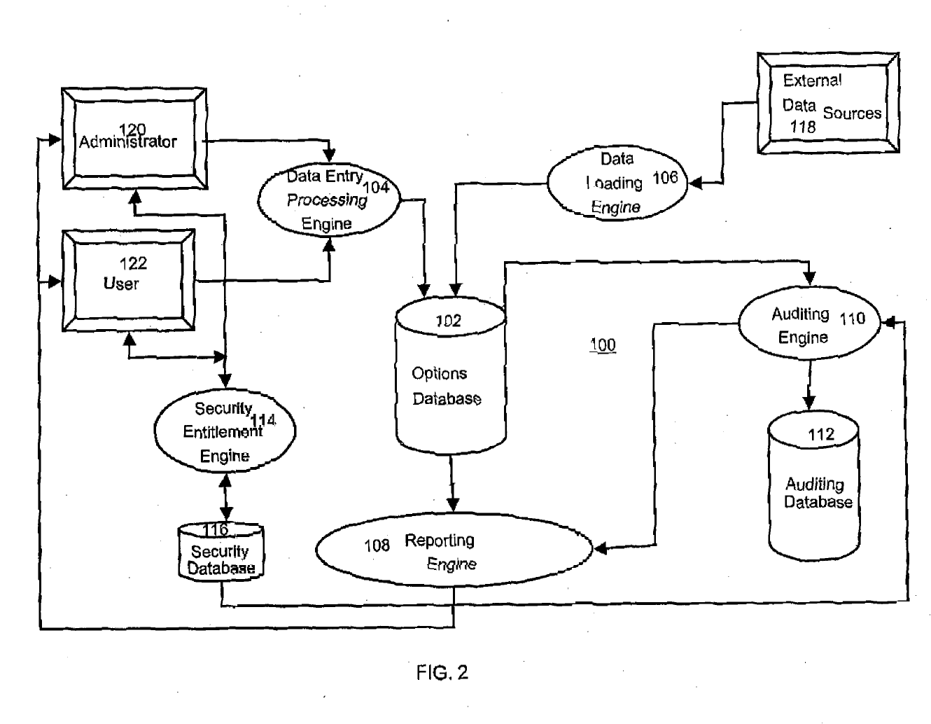

Referring now to FIG. 2 there is shown a block diagram of the system components 100 of an equity based compensation accounting system, according to an embodiment of the present. The system 100 includes an options database 102, a data entry-processing engine 104, a data-loading engine 106, a reporting engine 108, an auditing engine 110, an auditing database 112, a security entitlement engine 114 and security database 116. Each of these components and their interrelationship will be described below. The system 100 also includes so called external entities, which are sources or sinks of the data namely external data sources 118, an administrator 120 and user 122. The system 100 retrieves “public” information, such as the treasury interest rates and the stock price quotes from the external data sources 118.

In the illustrated embodiment the system is configured as a web service on a server computer to multiple clients(typically CFO's of individual companies), each client having a number of employees within their organization. Thus in this instance the administrator 120 is a user who has access to the administrative functions of the system 100 for administering user accounts, loading historical data for employees, uploading public information to the system and generating reports for the purpose of providing customer support. The user 122 is the client who uses the system 100. The client 122 provides information (in bulk format) about his or her employees to the administrator 120 to load the system, and can enter the information directly on the system. The user is the main user of the reporting functionality of the system.

The web service of the present invention may be accessed by at least one client device connected over a communication network. The communications network is any suitable communications link, such as a local area network (LAN), wide area network (WAN), the Internet, etc., a wireless network, or any combinations thereof. The client devices may also be connected to the web service computers via a proxy server. A client device is generally a multipurpose computer having a processor and memory that is capable of communicating with the server computers and also capable of displaying information received from the server computers. Client devices may be, for example, personal computers (PC), special purpose computers, workstations, wireless devices, such as personal digital assistants (PDA), cellular phones, two-way pagers, or any other devices that are capable of communicating with and receiving information from server computers.

In a preferred embodiment, the web/application server includes application programming logic that provides the functionality of the present invention. The server computers include program applications or the program modules/engines for manipulating data, displaying or causing to be displayed, on a client device, an administrator's interface screen including therein features and metrics associated with at least one employee stock plan relevant to a user logged on to the platform. The user interface organizes and presents relevant information, such as employee stock plan data, in a way that is easy to view. The user interface provides navigation and access to a plurality of interface screens for accessing various functionalities of the system.

The client devices preferably include programming therein, such as an Internet or Web browser application, for displaying a plurality of graphic user interface screens and for allowing users to communicate requests and data to the stock plan administration system, particularly to the server computers. The server computers are associated with one or more databases populated with information relevant for administering employee stock plans, including information pertaining to participants, stock plans, stock prices, etc. as will be discussed in more detail below.

The data stores hold the “data at rest” in the system and are sets of normalized relational tables and include the security database 116, the options database 102 and the auditing database 112.

The security database 116 comprises a set of tables that hold the information for the different users and their companies including basic identification information, authorizations and entitlements. The tables of the security database 114 associate users with roles, and associates roles with modules in the system, and this determines the entitlement of the users to access the various functional aspects of the system 100. In addition the security database stores the relationship between the users 122 and the different companies managed within the system.

The options database 102 holds all the options information including, but not limited to, companies, employees, contracts and transactions. Details of this database are described later. The auditing database 112 holds all the transactions that have taken place on the options database 102 and security database 116, and maintains a structured audit trail of these transactions.

The system 100 includes different processes which manipulate and move data among the different external entities 118, 120, 122 and data stores 102, 112 and following is a brief description of each:

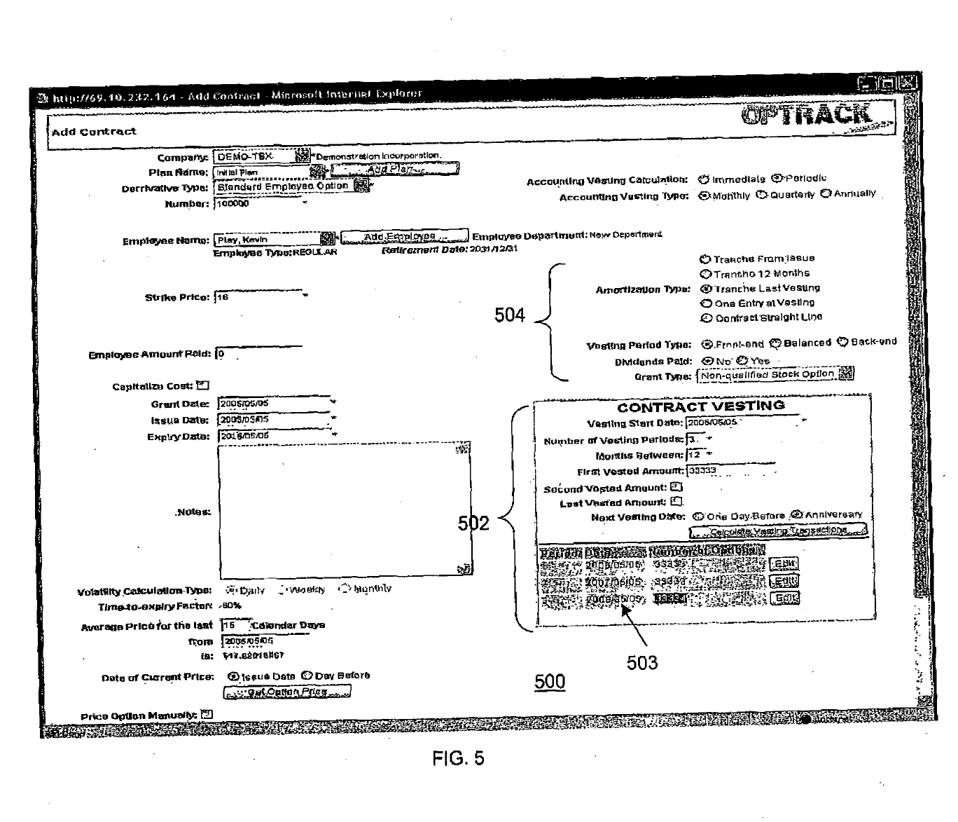

The data processing engine 104 includes a set of modules that allow users 122 and administrators 120 to enter data directly from the user interface (not shown). The data processing engine module 104 creates the expensing (amortization) transaction data from the input vesting transaction data 502, 504 input via the graphical user interface screen shown in FIG. 5, and stores it on the options database 102. In addition, these modules maintain the integrity of the database by applying the business rules to the data entered by the users, and generating the necessary data elements for populating the normalized database structure of the options database.

In addition to loading the public information that is supplied by the external data sources 118, the data-loading engine 106 performs basically the same functions as the data entry-processing engine 104. The main difference is that the data-loading engine 106 performs these functions “in bulk”, that is, multiple records are entered to the options database 102 in one step, while the data entry-processing engine 104 performs these functions one record at a time. This “bulk loading” functionality is used in loading the historical data for the various companies managed by the web service and when bulk changes are required.

The reporting engine 108 comprises a set of modules that provide the users with requested formatted data for their financial disclosures. The reporting engine generates reports in three main categories, namely sub-ledger reports, expense reports and statistical reports.

The security entitlement engine 114 includes a set of modules that act as the gatekeeper for the system 100. These modules manage the creation of the user accounts together with their authorization and entitlements. In addition the security entitlement engine 114 manages all aspects of logging in to the system, providing them with the accounting functions they are entitled to and for the companies they are authorized to access.

The auditing engine 110 is a set of software modules that populates the auditing database 112 with the record of all transactions, as an audit trail of all transactions that are performed on the options database 102 and the security database 116. In addition, the auditing engine 110 provides the reporting engine 108 with the audit trails that may be used in the generation of the different reports.

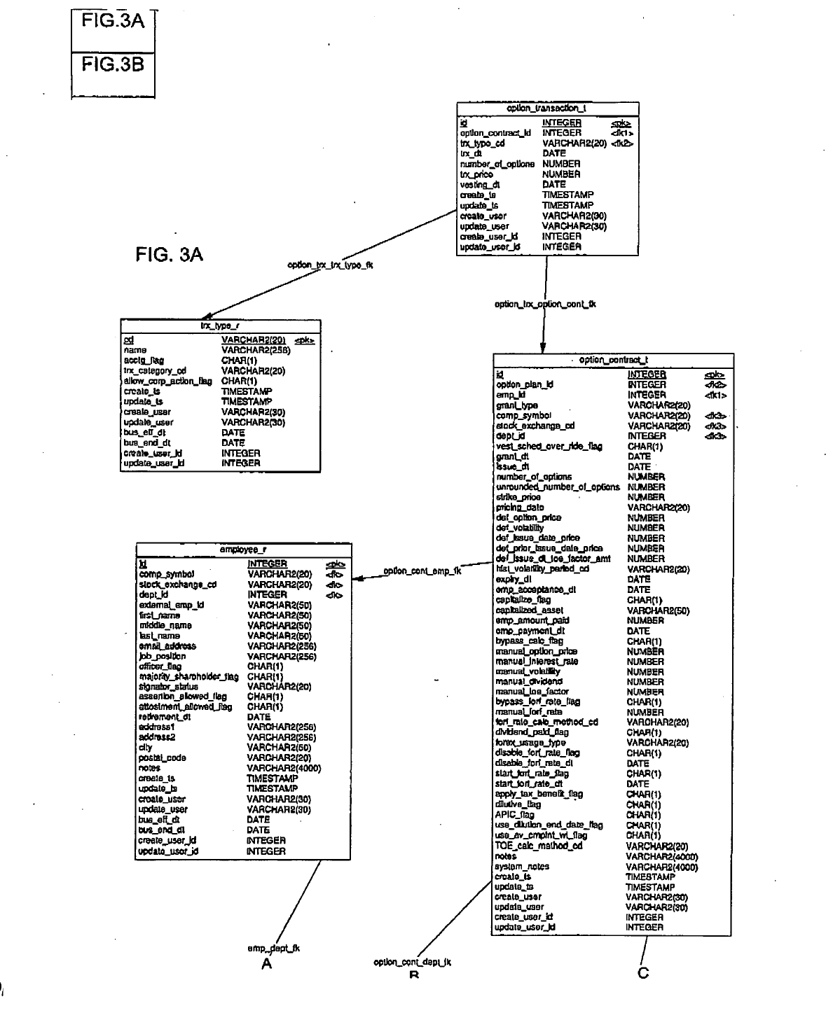

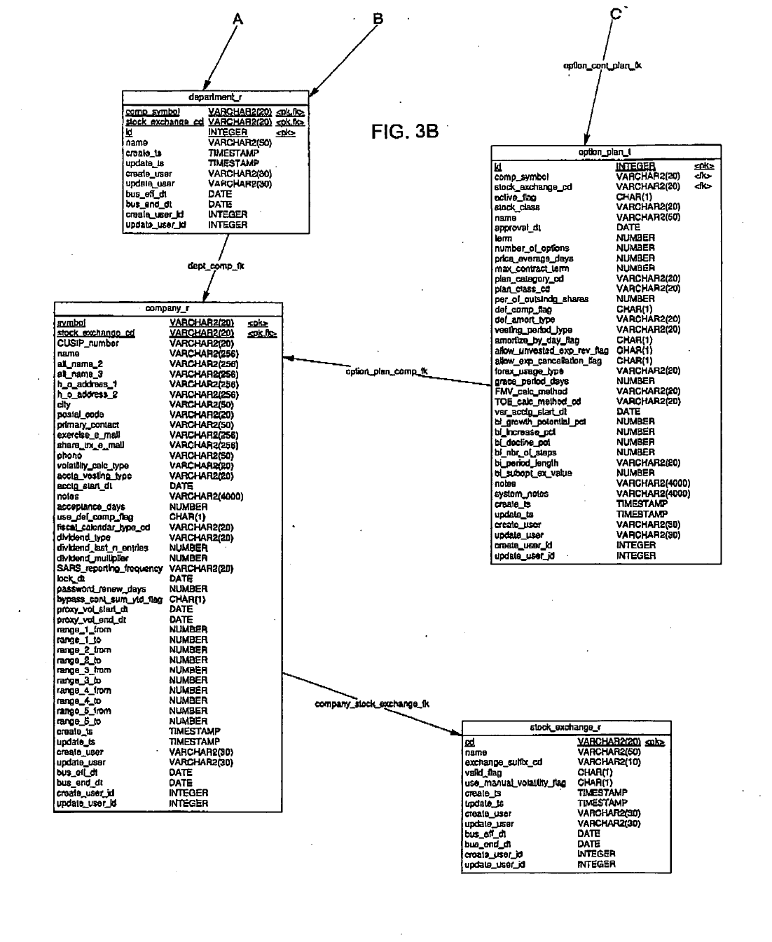

Referring to FIG. 3 there is shown an entity relationship diagram (ERD) 300 that describes the attributes of entities and the relationships among them, and illustrates the basic data abstraction of an embodiment of the options database 102. As known to those skilled in the art, an ERD is a conceptual representation of real world objects and the relationships between them. It defmes information that the systems create, maintain, process, and delete, as well as the inherent relationships that are supported by the database 102.

As known to those skilled in the art, a data dictionary, as provided in the table below, defines and specifies the data elements in the system. The table lists the various tables in the options database 102.

Table list

| Database table name | Description |
|---|---|
| Accounting_entry_r | This reference table holds the list of accounting entries |
| | associated with the different accounting transactions types. |
| blackout_period_t | This table holds the different blackout periods for different |
| | groups of employees. These blackout periods are used for two |
| | purposes: If an exercise of an option happens within a blackout |
| | period, the system would not allow it. The other purpose is for |
| | calculating the binomial FMV (fair market value) of the option |
| | price. |
| broker_r | This table holds the different brokerage firms that could be |
| | associated with a company. A single broker can serve every |
| | plan, and accordingly, multiple brokers could be servicing the |
| | same company though the different plans. |
| column_def_r | This reference table holds the names of the columns in the tables |
| | that we can download from the database. |
| comp_calendar_t | This table holds the definition of the quarters for a company. |
| | Either this table is used, or the table comp_specific_calendar_t |
| | is used to identify the fiscal quarters of a company. |
| comp_price_range_r | This reference table holds the different reporting price ranges for |
| | every department in a company. The number of ranges for every |
| | company, and the values for these ranges are variable for every |
| | company. |
| comp_variable_calendar_t | This table holds the definition of the specific quarters for a |
| | company. Either this table is used, or the table comp_calendar_t |
| | (which contains the fixed quarter starts and ends) is used to |
| | identify the fiscal quarters of a company. |
| company_dividend_t | This table holds the different dividends that companies declare. |
| | The table is used to obtain the total dividends for the last year to |
| | be used in the options calculation. Alternatively, the users may |
| | also change the estimated dividend on this table. |
| company_r | This is the company that issues the options. |
| company_tax_t | This table holds the different statutory tax rates for the |
| | companies. |
| company_volatility_t | This table holds the volatilities that are identified by private |
| | companies, or companies belonging to exchanges where |
| | volatility calculations could not be conducted |
| country_r | This reference table holds the different countries that are |
| | supported. |
| currency_r | This reference table holds the different currencies. |
| Department_r | This reference table holds the different departments belonging to |
| | a company. Every company sets up its own names and codes. |
| | The table starts with one single department named “HO”, or |
| | “Head Office”. |
| Derivative_type_r | This reference table holds the different types of derivatives, for |
| | example, rights, options, warrants, . . . |
| emp_share_trx_t | This transaction table holds the specific transactions associated |
| | with the stocks of an employee. These are the non-derivative |
| | transactions that impact the number of shares held by the |
| | employee (like buys and sells, for example). |
| emp_share_trx_type_r | This reference table holds the different types of non-derivative |
| | transactions that impact the number of shares of a company. |
| | Examples are buys (ADD) and sell (SUBTRACT). |
| employee_letter_r | This reference table holds the different formats of letters that |
| | could be issued to employees. |
| employee_r | This table is the employee of the company that receives the |
| | options. |
| employee_type_r | This reference table holds the different types of employees, for |
| | example, director, consultant, employee, . . . |
| esop_emp_contract_t | This table holds the ESOP contracts associated with employees. |
| | The presence of an entry in this table indicates that the employee |
| | is participating in a specific ESOP. |
| esop_emp_trx_t | This transaction table holds the specific transactions associated |
| | with an ESOP for an employee. |
| esop_emp_trx_type_r | This reference table holds the different types of esop |
| | transactions associated with employees, for example, paying for |
| | the shares, receiving the shares, . . . |
| esop_t | The table holds the plan data that the company defined for |
| | employee share ownership |
| esop_transaction_t | This transaction table holds the global transactions associated |
| | with an ESOP. These transactions are mostly associated with the |
| | purchase of shares from the market. |
| esop_trx_type_r | This reference table holds the different types of esop |
| | transactions, for example, buying shares from the market, and |
| | issuing shares from treasury, . . . |
| esop_type_r | This reference table holds the different types of esops, for |
| | example, ESOP from treasury and ESOP from market. Each of |
| | these plans will have its own accounting rules. |
| exchange_rate_t | This table holds the currency exchange rates associated with a |
| | specific company. |
| exercise_request_t | This transaction table holds the different exercise requests that |
| | the employees make. |
| exercise_trx_details_t | This table holds the different values associated with exercise |
| | transactions. |
| forfeiture_rate_t | This table holds the forfeiture rate that is applied to the number |
| | of shares (or the price of the option) to give us the actual amount |
| | that would be expensed. It is linked to the department rather |
| | than the company because every group of employees may have |
| | their own forfeiture rate. |
| form_type_r | This reference table holds the different types of reporting forms |
| | that are associated with regulatory reporting to the different |
| | exchanges |
| interest_rate_t | This table holds the different interest rates for different periods |
| | that are identified by the company. |
| mod_type_r | This reference table holds the different types of modifications |
| | that could happen to an options contract, for example, extending |
| | the expiry date, increasing the number of options, splitting the |
| | shares, etc. |
| option_contract_mod_t | This transaction table holds the modifications that happen to the |
| | option contract subsequent to its issuance. |
| option_contract_t | This table holds the derivative contracts granted to employees, |
| | consultants, directors, or optioned in general. |
| option_perf_criteria_t | This transaction table holds the performance criteria associated |
| | with an option contract when the criteria are related to stock |
| | prices. |
| option_plan_t | This table holds the plan data that the company defined to grant |
| | options or shares to employees. |
| option_plan_type_r | This reference table holds the different types of option plans, for |
| | example, Share Appreciation Right plan, Standard Options Plan, |
| | Tandem Plan, . . . Each of these plans will have its own |
| | accounting rules for expensing the derivatives. |
| option_transaction_t | This transaction table holds the specific transactions associated |
| | with an option (contract). |
| plan_type_derr_type_b | This table identifies which derivative types are allowed for |
| | every option plan type, for example, rights for Share |
| | Appreciation Rights and options, rights and warrants for Regular |
| | Option Plans, etc. |
| province_state_r | This reference table holds the different provinces (states) and |
| | their codes. |
| share_transaction_t | This transaction table holds the specific transactions associated |
| | with a stock transaction. These are the non-derivative |
| | transactions that impact the number of shares in a company. |
| share_trx_type_r | This reference table holds the different types of non-derivative |
| | transactions that impact the number of shares of a company. |
| | Examples are private placements (ADD) and share buyback |
| | (SUBTRACT). |
| stock_exchange_form_b | This reference table holds the specific forms associated with |
| | exchanges. These forms are needed for regulatory reporting that |
| | is mandated upon performing certain option transactions, such |
| | as issuance, changing the strike price, changing the expiry date, |
| | exercising, expiry or canceling. |
| stock_exchange_r | This reference table holds the different stock exchanges. |
| stock_price_t | This table holds the closing prices and volume of the stocks. |
| table_def_r | This reference table holds the names of the tables that we can |
| | download from the database. |
| taxable_benefit_r | This table holds the taxable benefit percentage that applies to |
| | every country.. |
| toe_factor_t | This table holds the time-to-expiry factors that are used in |
| | calculating the price of the options through reducing the term-to- |
| | expiry by the time-to-expiry factor. It is linked to the department |
| | rather than the company because every group of employees may |
| | have their own Time-to-Expiry Factor. |
| trx_type_r | This reference table holds the different types of option |
| | transactions, for example, issuing, expiring, assigning, and |
| | exercising |
| user_comp_b | This reference table holds the association between companies |
| | and users. |

As mentioned earlier, the system generates a sub-ledger of accounts for all the options and derivative transactions that have an impact on the financial statements of the company. The processing of data to generate entries for this sub-ledger goes hand-in-hand with the database design. The options database 102 is fully normalized; hence the sub-ledger could not be just a “listing” of the database entries. Rather, the sub-ledger is dynamically generated from the normalized structure, on the fly, to a non-normalized structure, and then makes it available for reporting. The different normalized tables that are used in this function include: Company_r; Currency_r; Employee_r; Exchange_rate_t; Forfeiture rate_t; Option_contract_t; Option_perf_criteria_t; Option plan_t; Option_transaction_t; Stock_exchange_r; Stock_price_t; and Trx_type_r as described above.

Fiedls for some of theses tables are shown below:

Column list of the table company r:

| Field Name | Description of data |
|---|---|
| symbol | Company symbol |
| stock_exchange_cd | Stock exchange code |
| CUSIP_number | |
| name | |
| h_o_address_1 | |
| h_o_address_2 | |
| city | |
| country_cd | |
| province_state_cd | |
| currency_cd | This is the default currency of the company, which drives the |
| | currency_prefix and the currency_format. |
| postal_code | |
| exercise_e_mail | This is the e-mail that will be receiving the e-mail |
| | communications between the employee and the company |
| | when exercising options. |
| share_trx_e_mail | This is the e-mail that will be communicating to the company |
| | administrator when an employee puts in a transaction. |
| volatility_calc_type | This field holds the default that the company uses for |
| | calculating the volatility. Alternatives include DAILY and |
| | WEEKLY. |
| acctg_vesting_type | This field holds the default that the company uses for vesting |
| | the issued options. Alternatives include Monthly (MONTH), |
| | Quarterly (QUARTER) and Annually (YEAR). |
| acctg_start_dt | This is the date at which the company started recording its |
| | options on its books. Any transactions prior to that date are |
| | recorded, but reversals of these transactions after that date are |
| | not recorded on the books. |
| acceptance_days | These are the number of days after which the option grant is |
| | considered rejected in case the employee did not yet accept it. |
| use_def_comp_flag | This field determines whether the company is using the |
| | deferred compensation or not for the calculation of the |
| | financial transactions associated with the options transactions. |
| | For example, if it is ‘Y’, then upon issuance, we would debit |
| | the deferred compensation and credit the contributed surplus, |
| | and as the option is vested we would debit the stock-based- |
| | compensation and credit the deferred compensation. If it is |
| | ‘N’, we would only debit the stock-based-compensation and |
| | credit the contributed surplus as the options are vested. This |
| | value is the default for the company, and is picked up to |
| | populate the same field on the option_plan_t. |
| fiscal_calendar_type_cd | This field identifies if the fiscal calendar is a constant one |
| | (one that does not change over the years), or a variable one |
| | (one that changes every year). Most of the retail organizations |
| | would have a variable calendar type. |
| SARS_reporting_frequency | This field identifies how frequently SAR's are being reported |
| | on the financial statements. |

Column list of the table option contract t

| Field Name | Description |
|---|---|
| id | |
| option_plan_id | The plan to which the contract belongs |
| emp_id | Employee identification |
| derrivative_type_cd | The derivative type acceptable values are dependent on the |
| | type of the plan through the values in the |
| | DERRIVATIVE_PLAN_TYPE_B table |
| grant_type | This field identifies whether the grant is an Incentive Stock |
| | Option (ISO), aka, qualified stock option, or Non-qualified |
| | Stock Option (NSO). |
| comp_symbol | Company symbol |
| stock_exchange_cd | Exchange code |
| dept_id | Department |
| grant_dt | This is the date when the compensation committee (or the |
| | board of directors) approved the grant of the option to the |
| | employee. This is normally the issue_dt of the contract. |
| issue_dt | Issue date |
| number_of_options | Number of options |
| strike_price | Strike price |
| pricing_date | This field identifies whether the pricing of the option will be |
| | based on the issue date or based on the or on the date before |
| | the issue date date. |
| def_option_price | This option price is a temporary column that is populated |
| | when the company parameters are changed. The values in this |
| | column are populated based on the default values in the |
| | company_r table, namely the time_to_expiry_factor and the |
| | volatility_calc_type. |
| def_volatility | This field contains the system-calculated volatility for the |
| | contract. It will change upon changing the price, the interest |
| | rate, the TOE factor or the dividend of the company. The term |
| | of the contract and its strike price is not allowed to change |
| | except through a modification. |
| expiry_dt | Expiry date |
| emp_acceptance_dt | This field indicates the date at which the employee accepted |
| | the grant. This date has to be larger than the issue date of the |
| | option, and has to be within a certain number of days of the |
| | issue date (identified on the company_r table). A nullable |
| | field means that the employee did not yet accept the options |
| | grant. |
| capitalize_flag | This flag identifies whether the issuance of the option will be |
| | capitalized or not. If it is capitalized, it would be booked |
| | against an asset rather than an expense. If the flag is set to Y, |
| | then the the capitalized asset would need to be populated. |
| capitalized_asset | Capitalized asset |
| emp_amount_paid | This is the amount that the employee pays for the contract. |
| | This will mostly apply to SAR plans. |
| emp_payment_dt | Employee payment date |
| bypass_calc_flag | This field identifies whether the fair price of the option is |
| | system calculated (N), or manually by-passed (Y). |
| manual_option_price | This field contains the price that is entered by the user if they |
| | choose to by-pass the automatic calculation of the option |
| | prices. This should only be done in very specific situations |
| | where the option price could not be calculated, for example, if |
| | the strike price is dependent on external factors, and is not a |
| | static value. |
| manual_interest_rate | This is an informational field that the user enters to indicate |
| | which interest rate was used to over-ride the system- |
| | calculated fair market value (option price). |
| manual_volatility | This is an informational field that the user enters to indicate |
| | which volatility was used to over-ride the system-calculated |
| | fair market value (option price). |
| manual_dividend | This is an informational field that the user enters to indicate |
| | which dividend was used to over-ride the system-calculated |
| | fair market value (option price). |
| manual_toe_factor | This is an informational field that the user enters to indicate |
| | which time-to-expiry factor was used to over-ride the system- |
| | calculated fair market value (option price). |
| bypass_forf_rate_flag | This flag identifies whether the forfeiture rate to be used is |
| | the manual one associated with the contract (Y) or the default |
| | forfeiture rate associated with the contract department. |
| manual_forf_rate | This is the forfeiture rate that will apply only to this contract. |
| | If the rate is 3%, we would then hold the number 3. |
| dividend_paid_flag | This field identifies whether dividends are paid on the |
| | contract or not. In very special situations of SAR plans, |
| | dividends are paid on the contract. |
| forex_usage_type | This field identifies the foreign exchange rate to be used when |
| | calculating the financial transactions. The foreign exchange |
| | usage would normally be for ISSUEDATE regular employees |
| | and TRXDATE for consultants. |
| disable_forf_rate_flag | This field identifies whether the forfeiture rate application to |
| | the expenses will be disabled or not. The forfeiture rates |
| | would normally be disabled for “retiring employees”. Setting |
| | this field to “Y” would require that we populate the |
| | DISABLE_FORF_RATE_DT with the appropriate date at |
| | which this disabling would take place. This would normally |
| | be the date at which the employee becomes eligible for |
| | retirement. |
| disable_forf_rate_dt | This field identifies the date at which the forefieture rate will |
| | stop taking effect on the expenses of a contract. This date |
| | would normally be the date at which the employee becomes |
| | eligible for retirement. |

Column list of the table option perf criteria t:

| Field Name | Description |
|---|---|
| option_contract_id | |
| criterion_number | This is a number that identifies the sequence of the criterion |
| | within the option contract. |
| perf_dt | This is the date at which the performance measurement will |
| | be assessed |
| perf_stock_price | This is target stock price associated with the criterion. |
| perf_criterion_probability | This is the probability that such a criterion will take place. |
| number_of_vested_options | This is the number of options vested if that criterion is met. |
| notes | Whatever notes need to be entered associated with this |
| | performance criterion. |
| fulfillment_percent | Fulfillment percent |
| fulfilment_dt | Fulfillment date |
| update_user_id | |

Column list of the table option plan t:

| Name | Comment |
|---|---|
| id | |
| comp_symbol | Company symbol |
| stock_exchange_cd | Exchange |
| plan_type_cd | Plan type |
| def_emp_letter_cd | This field identifies the default employee grant letter that |
| | would be associated with the plan. |
| currency_cd | Currency code |
| broker_cd | Broker code |
| name | name |
| approval_dt | This is the date when the plan was approved by the |
| | shareholders. |
| term | The term is the number of years in which the plan is effective. |
| number_of_options | This is the maximum number of options that could be granted |
| | within the plan. |
| price_average_days | This field is used to calculate the strike price of the option |
| | contract. For example, if the value is 10, the strike price |
| | would be the average closing price of the shares in the last 10 |
| | days preceding the granting of the option. |
| max_contract_term | This is the maximum number of years that could be granted |
| | for a contract within the plan. |
| plan_category_cd | This field identifies whether the number of “granted” options |
| | are STANDARD (fixed number) or EVERGREEN |
| | (dependent on a percentage of the outstanding shares in the |
| | company). |
| plan_class_cd | This field identifies whether the plan is an options plan, |
| | OPTION (where it is then linked to the option_contract_t |
| | table), or is an Employee Share Ownership Plan, ESOP, |
| | where it is then linked to the esop_t table). The default is |
| | OPTION. |
| per_of_outstndg_shares | This is the percentage of outstanding shares that would apply |
| | to plans of category EVERGREEN. |
| def_comp_flag | This field determines whether the company is using the |
| | deferred compensation or not for the calculation of the |
| | financial transactions associated with the options transactions. |
| | For example, if it is ‘Y’, then upon issuance, we would debit |
| | the deferred compensation and credit the contributed surplus |
| | account, and as the option is vested we would debit the stock- |
| | based-compensation and credit the deferred compensation |
| | accounts. If it is ‘N’, we would only debit the stock-based- |
| | compensation and credit the contributed surplus as the options |
| | are vested. The default value is picked up from the |
| | corresponding value on the company_r table. |
| FMV_calc_method | This field identifies whether the fair market value will be |
| | based on the intrinsic value of the derrivative, the Black |
| | Scholes value or the Lattice/Binomial value. |
| bi_growth_potential_pct | The growth potential in the binomial model |
| bi_increase_pct | The potential increase in every step in the binomial model. |
| bi_decline_pct | The potential decline in every step in the binomial model. |
| bi_nbr_of_steps | The number of steps that will be used in the binomial model. |
| bi_period_length | This field identifies the length of every period in the binomial |
| | model. The pre-defined lengths are WEEKLY, MONTHLY, |
| | QUARTERLY, SEMIANNUAL and ANNUAL. |
| bi_subopt_ex_value | Binomial Suboptimal Exercise Value; this value identifies |
| | when employees would be “sub-optimally” exercising their |
| | option, that is, exercise it prior to the expiry date. For |
| | example, a value of 2 would indicate that the employee would |
| | exercise the option when the price of the underlying secuiry |
| | hits twice the stike price. |
| update_user_id | |

Column list of the table option transaction t:

| Name | Comment |
|---|---|
| id | |
| option_contract_id | Option contract id |
| trx_type_cd | Transaction type |
| trx_dt | Transaction date |
| number_of_options | Number of options |
| trx_price | price |
| vesting_dt | This is the date that will be used in |
| | providing the reversal accounting transactions. |
| | This field will only be populated for |
| | “EXERCISE” transactions. |
| update_user_id | |

Column list of the table trx type r:

| Name | Comment |
|---|---|
| cd | |
| name | name |
| acctg_flag | The only accounting type transaction would be |
| | ACCTGVEST. |
| trx_category_cd | This flag identifies if the category |
| | of transaction, which is used in the |
| | reporting of different categories. |
| update_user_id | |

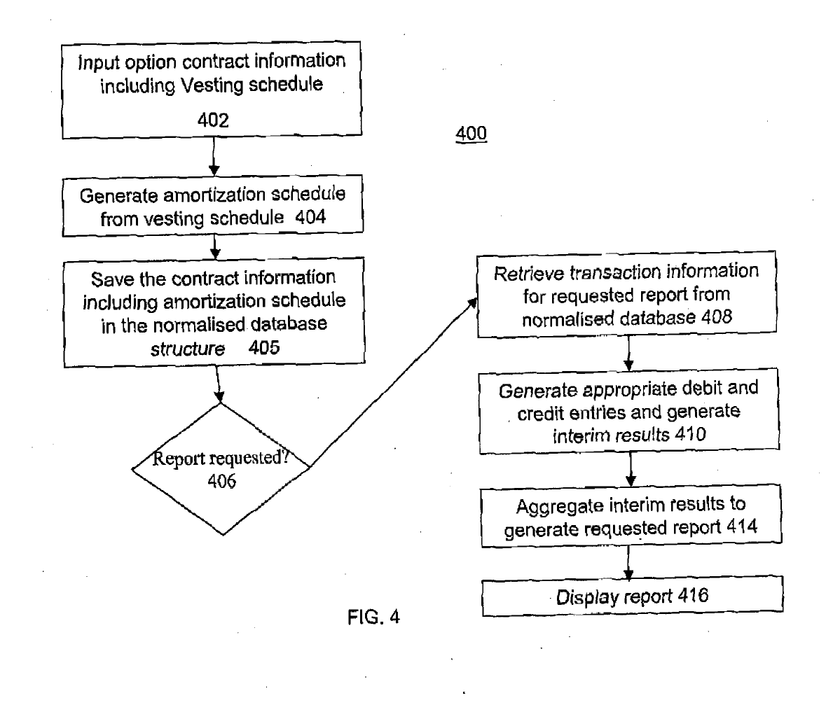

Referring now to FIG. 4 there is shown a method 400 by which we generate the denormalized structure of these tables from the normalized structure. At step 402 option contract information relating to the granting of the employee equity based compensation is input, typically via a GUI screen, an exemplary embodiment of which is shown in FIG. 5. The options contract information at step 404 is saved in the appropriate normalized database tables as defined above. As shown in FIG. 5, this information includes amortization information 502 which is generated from vesting schedule information 504, this is generally termed granting information. At step 406 when a report is requested, a query is issued step 408 to the normalized tables in the options database to retrieve the appropriate data fields from the granting information and a set of interim debit and credit transactions are generated 410, these interim results 412 are aggregated to generate the requested report 414.

As may be seen, the method is based on breaking down the sub-ledger business rule into smaller business rules, each of which can be executed separately to provide intermediate results which then can be combined to produce a final result—this technique provides manageability of the program code defining the business rules—and combining the outcome of the different smaller business rules into a single list that is then sorted to produce the sub ledger.

The expensing transactions for the options is directly related to the vesting schedule for the options, and deriving the expensing transaction based on the vesting schedule is the normal implementation in case of options management. However, in the present system these two transactions are separated, and linked by a date (“logical”) foreign key (the vesting date ) with the expensing transaction record to indicate which vesting transaction record it is based on.

This implementation is again counter-intuitive, which is “de-normalization” of the database structure, is important to provide flexibility to the database, and at the same time improve the performance of the system. Previous systems do not store the expensing transaction on the database, but calculate them on the fly which reduces performance and stability of the system.

Without the breakdown of the vesting and the accounting vesting (expensing or amortization) transactions, the generation of the sub ledger using the method described above, although still possible, performance-wise, would not be practical, as the derivation of the expenses will need to be done for every line item in the sub ledger. Instead, other solutions tend to “store” the sub ledger double entries on the system which, while fixing the performance problem, introduces significant flexibility issues associated with the system; with double-entries in place, no changes could be done except with double entry reversal transactions.

As is well known the employee stock option expensing from a purely technical accounting perspective involves a “debit” entry that requires an equal an opposite, or “credit” entry; every accounting entry requires an accurate measurement or estimate of the accounting variable in question; and the progression of the entries through the expiration of the stock option contract must be specified.

Following are tables that show a screen output for the sub ledger including the generation of the double entries (debits and credits) from the different transactions (e.g. amortization, expensing, and expiry).

Sub Ledger report:

| | Type | Account | Amount | Comment |
|---|---|---|---|---|
| | Debit | Stock Based | $3,142.02 | 2006/05/05 “accounting” vesting of 6250 Options issued to Victor Abbas on |
| | | Compensation | | 2005/05/05 at a strike price of $16.58 |
| | Credit | Contributed | $3,142.02 | 2006/05/05 “accounting” vesting of 6250 Options issued to Victor Abbas on |
| | | Surplus | | 2005/05/05 at a strike price of $16.58 |
| Aug. 5, 2005 | Debit | Stock Based | $3,142.02 | 2006/05/05 “accounting” vesting of 6250 Options issued to Victor Abbas on |
| | | Compensation | | 2005/05/05 at a strike price of $16.58 |
| | Credit | Contributed | $3,142.02 | 2006/05/05 “accounting” vesting of 6250 Options issued to Victor Abbas on |
| | | Surplus | | 2005/05/05 at a strike price of $16.58 |
| Nov. 5, 2005 | Debit | Stock Based | $3,142.02 | 2006/05/05 “accounting” vesting of 6250 Options issued to Victor Abbas on |
| | | Compensation | | 2005/05/05 at a strike price of $16.58 |
| | Credit | Contributed | $3,142.02 | 2006/05/05 “accounting” vesting of 6250 Options issued to Victor Abbas on |
| | | Surplus | | 2005/05/05 at a strike price of $16.58 |
| Feb. 5, 2006 | Debit | Stock Based | $3,142.02 | 2006/05/05 “accounting” vesting of 6250 Options issued to Victor Abbas on |
| | | Compensation | | 2005/05/05 at a strike price of $16.58 |
| | Credit | Contributed | $3,142.02 | 2006/05/05 “accounting” vesting of 6250 Options issued to Victor Abbas on |
| | | Surplus | | 2005/05/05 at a strike price of $16.58 |
| May 5, 2006 | Debit | Stock Based | $3,142.02 | 2007/05/05 “accounting” vesting of 6250 Options issued to Victor Abbas on |
| | | Compensation | | 2005/05/05 at a strike price of $16.58 |
| | Credit | Contributed | $3,142.02 | 2007/05/05 “accounting” vesting of 6250 Options issued to Victor Abbas on |
| | | Surplus | | 2005/05/05 at a strike price of $16.58 |
| Aug. 5, 2006 | Debit | Stock Based | $3,142.02 | 2007/05/05 “accounting” vesting of 6250 Options issued to Victor Abbas on |
| | | Compensation | | 2005/05/05 at a strike price of $16.58 |
| | Credit | Contributed | $3,142.02 | 2007/05/05 “accounting” vesting of 6250 Options issued to Victor Abbas on |
| | | Surplus | | 2005/05/05 at a strike price of $16.58 |
| Oct. 5, 2006 | Debit | Cash | $331,600.00 | Exercising of 20000 Options issued to Victor Abbas on 2005/05/05 at $16.58 |
| | Credit | Share Capital - | $331,600.00 | Exercising of 20000 Options issued to Victor Abbas on 2005/05/05 at $16.58 |
| | | Stocks | | |
| | Debit | Contributed | $10,054.47 | Exercising of 20000 Options issued to Victor Abbas on 2005/05/05 at $16.58 |
| | | Surplus | | |
| | Credit | Share Capital - | $10,054.47 | Exercising of 20000 Options issued to Victor Abbas on 2005/05/05 at $16.58 |
| | | Options | | |
| Nov. 5, 2006 | Debit | Stock Based | $3,142.02 | 2007/05/05 “accounting” vesting of 6250 Options issued to Victor Abbas on |
| | | Compensation | | 2005/05/05 at a strike price of $16.58 |
| | Credit | Contributed | $3,142.02 | 2007/05/05 “accounting” vesting of 6250 Options issued to Victor Abbas on |
| | | Surplus | | 2005/05/05 at a strike price of $16.58 |
| Dec. 25, 2006 | Debit | Stock Based | ($3,142.02) | 2006/05/05 “accounting” vesting of −6250 Options issued to Victor Abbas on |
| | | Compensation | | 2005/05/05 at a strike price of $16.58 |
| | Credit | Contributed | ($3,142.02) | 2006/05/05 “accounting” vesting of −6250 Options issued to Victor Abbas on |
| | | Surplus | | 2005/05/05 at a strike price of $16.58 |
| Dec. 25, 2006 | Debit | Stock Based | ($3,142.02) | 2006/08/05 “accounting” vesting of −6250 Options issued to Victor Abbas on |
| | | Compensation | | 2005/05/05 at a strike price of $16.58 |
| | Credit | Contributed | ($3,142.02) | 2006/08/05 “accounting” vesting of −6250 Options issued to Victor Abbas on |
| | | Surplus | | 2005/05/05 at a strike price of $16.58 |
| Dec. 25, 2006 | Debit | Stock Based | ($3,142.02) | 2006/11/05 “accounting” vesting of −6250 Options issued to Victor Abbas on |
| | | Compensation | | 2005/05/05 at a strike price of $16.58 |
| | Credit | Contributed | ($3,142.02) | 2006/11/05 “accounting” vesting of −6250 Options issued to Victor Abbas on |
| | | Surplus | | 2005/05/05 at a strike price of $16.58 |

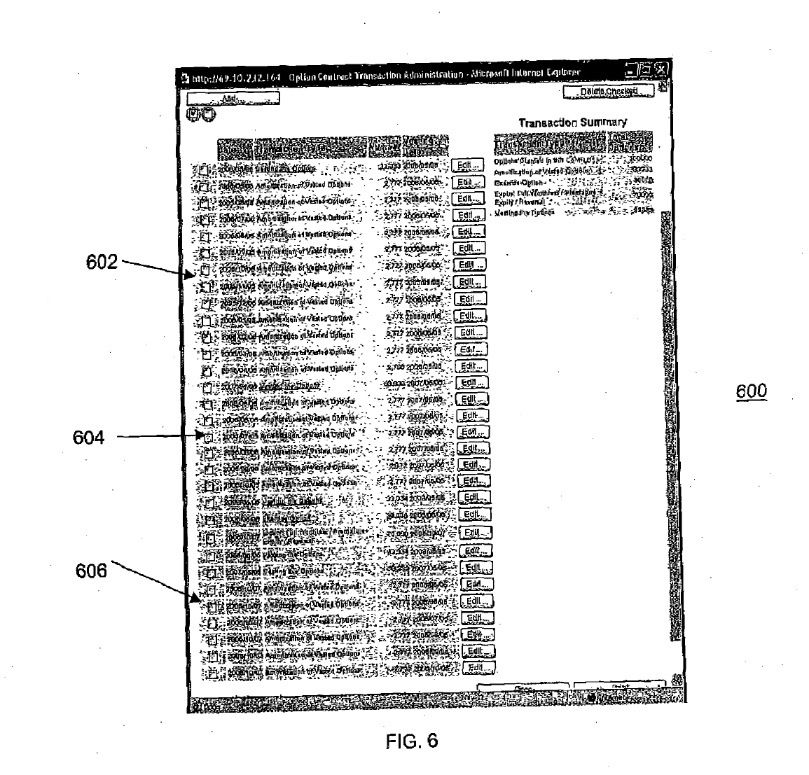

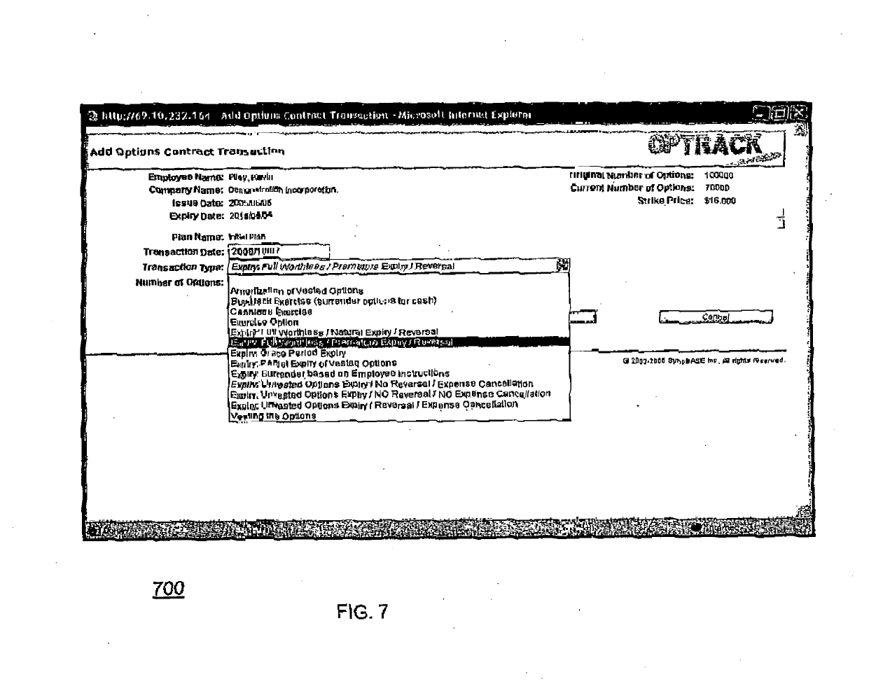

Referring to FIG. 6 there is shown the amortization schedule 600 for the vesting schedule 504 of FIG. 5. As may be seen the amortization of the first and second tranche is shown at 602 and 604. While a reversal is shown at 606. The debit and credit entries for the subledger generated from the amortization transactions in FIG. 6 are shown in the table above. FIG. 7 shows the option plan setup screen.

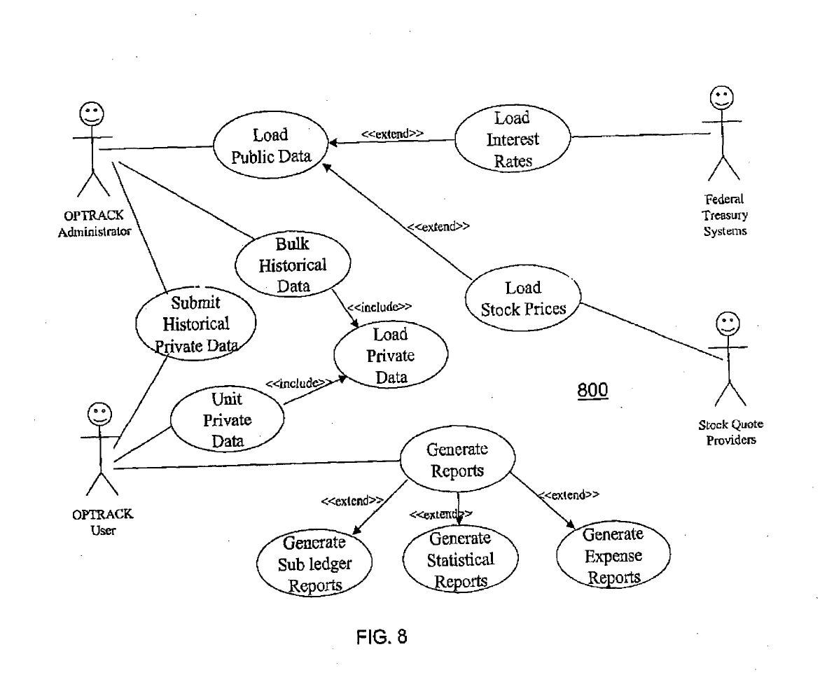

Referring now to FIG. 8 there is shown a use-case diagram describing the usage of the system 100 as it pertains to the different “users”. The users of the system here are equivalent to the “external entities in the data flow diagram. Please note that the use case diagram does not describe the functionality of the system, but rather its usage. There are three types of relationships in the use case diagram:
Usage relationships: describing which user uses which process (aka, use case). Straight lines with no arrows describe these relationships.
Extend relationships: describing processes that are inheriting the properties and usages of their parent processes. Arrows with <<extend>> labels point from the child process to its generalized process.
Include relationships: describing processes that are invoked by other processes. Arrows with <<include>> labels point from the invoking process to the invoked process.

The use case diagram describes the following relationships:

The Administrator is associated with Loading Public Data, Bulk Loading of Historical Data, and the Submission of the Historical Data.

The User is associated with the Submission of the Historical Data, entry of the Unit Private Data and the Generation of the Reports.

The Bulk Loading functionality is either for loading the stock prices or the interest rate, and these two processes are associated with the Federal Treasury Systems and the Quote Providers. The loading of the Bulk Historical Data and the loading of the Unit Data processes are both using the loading of the private data, which takes care of generating the expense transactions from the vesting transactions. The generation of the report is associated with the three types of reports namely sub ledger reports, expense reports and statistical reports.

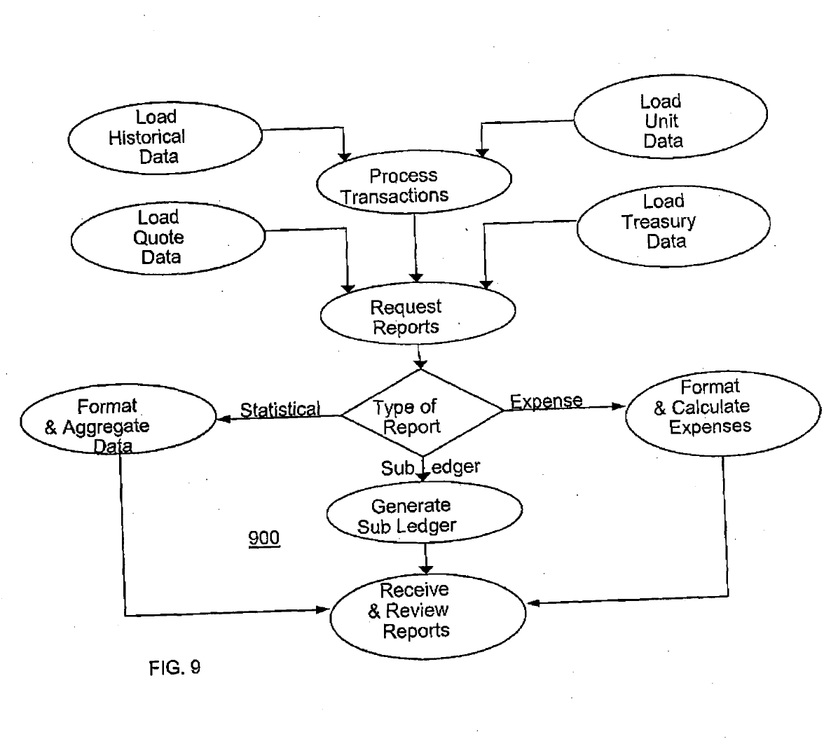

Referring to FIG. 9 there is shown a flow chart 900 of how the different functions of the system 100 interact with each other.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the present invention. All such changes and modifications are intended to be included within the scope of the invention as defined by the appended claims.

We claim:

1. A system for employee equity based compensation accounting, comprising:
a database for storing granting information derived from one or more equity based compensation grants to an employee, said database being configured to have a normalized data structure for storing said granting information; and
a reporting module for generating from said stored granting information accounting entries corresponding to plurality of sub ledger accounts, the accounts representing accounting debits and credits in said sub ledger for at least one of issuing, expensing, exercising and expiring one or more of said equity based compensation grants.

2. A system as defined in claim 1, said granting information including a vesting schedule and corresponding amortization schedule.

3. A system as defined in claim 2, including a data processing engine for generating said amortization schedule form said vesting schedule.

4. A system as defined in claim 3, including a graphical user interface for inputting said granting information.

5. A system as defined in claim 1, including a data loading engine for loading multiple records into said normalized database structure.

6. A method for employee equity based compensation accounting, comprising the steps of:
Storing in a database granting information derived from one or more equity based compensation grants to an employee, said database being configured to have a normalized data structure for storing said granting information; and
generating from a reporting module for generating from said stored granting information accounting entries corresponding to plurality of sub ledger accounts, the accounts representing accounting debits and credits in said sub ledger for at least one of issuing, expensing, exercising and expiring one or more of said equity based compensation grants.

7. A system for processing data on a general purpose computer for a plurality of equity based compensation plans and a plurality of participants, each of the compensation plans having a time-variant unit value, the system comprising:
(a) transaction storage for storing transaction records containing externally-supplied grant transaction information, said grant transaction information identifying one of the participants, at least one equity type, an equity type unit value, a transaction effective date, a transaction type, an amount of equity unit granted to the identified participant and a schedule for vesting of said equity type with said participant;
(b) amortization storage for storing an amortization schedule generated from said schedule for vesting; and
(c) a report generation module coupled to said transaction storage and to said amortization storage for extracting data from the transaction records and generating debits and credits using the equity type, transaction effective date and amortization schedule to determine the equity based compensation plan value as of the transaction effective date.
